(19) United States
(12) Patent Application Publication
(10) Pub. No.: US 2003/0064177 A1
(43) Pub. Date: Apr. 3, 2003

(54) Solution retaining device and stand

(76) Inventor: George Thomas Sawyer, Orem, UT (US)

Correspondence Address: George Thomas Sawyer, 1360 W 130 S, OREM, UT, 84058, US

(21) Appl. No.: 10/254,490

(22) Filed: Sep. 25, 2002

Related U.S. Application Data
(60) Provisional application No. 60/325,958, filed on Oct. 1, 2001.

(51) Int. Cl. F16L 1/00

(52) U.S. Cl. 428/34.1

(57) ABSTRACT

In contrast to the Magic Rocks™ product where colorful crystalline material in decorative shapes grow submerged in water, this invention relates to improvements in colorful crystalline material in decorative shapes that grow in air, and are more fully described in U.S. Pat. No. 4,196,239, issued Apr. 1, 1980. These shapes, that may be in the form of a tree, that grow in air are created by using (1) absorbent material placed in a liquid of a solid dissolved in water, and (2) the liquid is contained by a liquid holder, as a saucer, and (3) the liquid wicks up the absorbent material to the extremities where the water evaporates, and (4) the solid crystallizes into beautiful decorative shapes.

Because saucers as liquid holders are flat and difficult to grasp and to move without spilling, this invention teaches elevating the liquid holder with a support that is easily grasped. Because some paper cups, as Dixie® 58AD 5 ounce, have an adequate depression in the bottom to serve as a liquid holder, this cup is ideal to use when inverted; the depression serves as a liquid holder, and the body of the cup serves as a support that is easily grasped with small or large hands and the assembly can be easily moved without spilling the liquid.

### BACKGROUND OF THE INVENTION

### What is Happening?

The contents of referenced U.S. Pat. No. 4,196,239 (U.S. Pat. No.-239) relate directly to this invention. FIG. 1, of instant invention, is essentially like FIG. 4 of U.S. Pat. No. 4,196,239.

Referring to said FIG. 1, liquid 11 exists wherein the liquid 11 contains a solid material dissolved in water and the solid material is capable of crystallizing as the water evaporates. This liquid is placed in a liquid holder, as a saucer, 12. An absorbent material 13 is placed in contact with the liquid 11. The liquid 11 is absorbed by the absorbent material 13 and goes out to the tips of the absorbent material 13 that are shaped, in this case, like the branches of a tree. The water evaporates from the liquid at the tips, making the solution more saturated with solid material and the solid material wants to, and does, form decorative crystalline growths 14. Many possible shapes using this process are shown in

### DEFINITIONS

A decorative crystalline-growth in air (e.g. the product “Magic® Tree”), as 14, is an object created by the drying and crystallization of a liquid 11, that comprises a solid dissolved in water and is supported on absorbent material 13 such as blotter paper. A liquid holder 12 is any of a variety of devices that are used to hold the liquid from escaping, and to keep the liquid in close proximity to the absorbent material 13 until the drying and crystallization is complete. Liquid holders comprise trays, saucers, small plates, dishes, dams, etc., and indeed any device used to constrain the movement of a liquid.

### PRIOR ART

Examples of prior art include small saucers and trays. These liquid holding devices minimize the spread of the liquid, maximizing the amount of liquid that is ultimately drawn into the absorbent material. Without such a liquid holder, much of the liquid evaporates or flows away, thus reducing the amount of liquid drawn into the absorbent material, which reduces the amount of desired crystallization on the absorbent material. An example of prior art is the Magic Christmas Tree® presently produced by New Tomorrow, Inc., 1360 West, 130 South, Orem, Utah, 84058. This product teaches the use of a saucer as a liquid holder. Examples of various shapes are shown in U.S. Pat. No.-239. These examples of prior art suggest the use of liquid holders wherein their distance across is large compared to their depth, an example being a saucer.

### DISADVANTAGE OF PRIOR ART

Prior art liquid holders, although providing a measure of liquid retention, are unwieldy and awkward to move during and after the crystallization process. This is due in part to the high aspect ratio of width to height and the lack of vertical gripping surfaces. The aspect ratio, in the case of a saucer, as shown in FIG. 2, wherein the distance across the saucer W divided by the height 1f of the saucer above the table top 22. The high aspect ratio promotes rocking or “wobbling” of the decorative crystalline growth, while the lack of vertical gripping surfaces reduces the ability of a person to manipulate the decorative crystallinel growth, as when a person wishes to carry the decorative crystalline growth from one place to another. The aspect ratio of a liquid holder is defined as the ratio of the width W of the liquid holder to the height H of the liquid holder above the surface on which the liquid holder rests. FIG. 2 shows an example of a prior art liquid holder 21 that is a saucer, the height of the device is shown as H, and its width is shown as W. The aspect ratio is W divided by H (or W/H). The aspect ratio, of all liquid holders known to the inventor as prior art, is more than 2. The height of all liquid holders known to the inventor as prior art, is less than ¾-inch.

### BRIEF SUMMARY OF THE INVENTION

### Teachings of the Invention

The invention teaches the use of a liquid holder that provides liquid retention properties, and said liquid holder can be handled or grasped by small hands as well as large hands, and facilitates manipulation by providing vertical gripping surfaces, and provides a stable platform upon which the decorative crystalline growth rests. Additionally, the liquid holder provides a convenient medium for printed communication, and is readily available.

FIG. 3 shows liquid being poured into the preferred liquid holder

FIG. 4 shows the absorbent material as it sets in the liquid holder,

FIG. 5 shows the decorative crystalline growths on the absorbent material and supported by the liquid holder,

### BRIEF DESCRIPTION OF THE DRAWINGS

FIG. 1 shows an example of a prior art liquid holder that is, in this case, a saucer 12

FIG. 2 shows a cross section of a saucer that illustrates the term “aspect ratio.”

FIG. 3 shows liquid being poured into the improved liquid holder.

FIG. 4 shows the absorbent material as it sets in the liquid within the improved liquid holder.

FIG. 5 shows the decorative crystalline growths on the absorbent material and supported by the improved liquid holder.

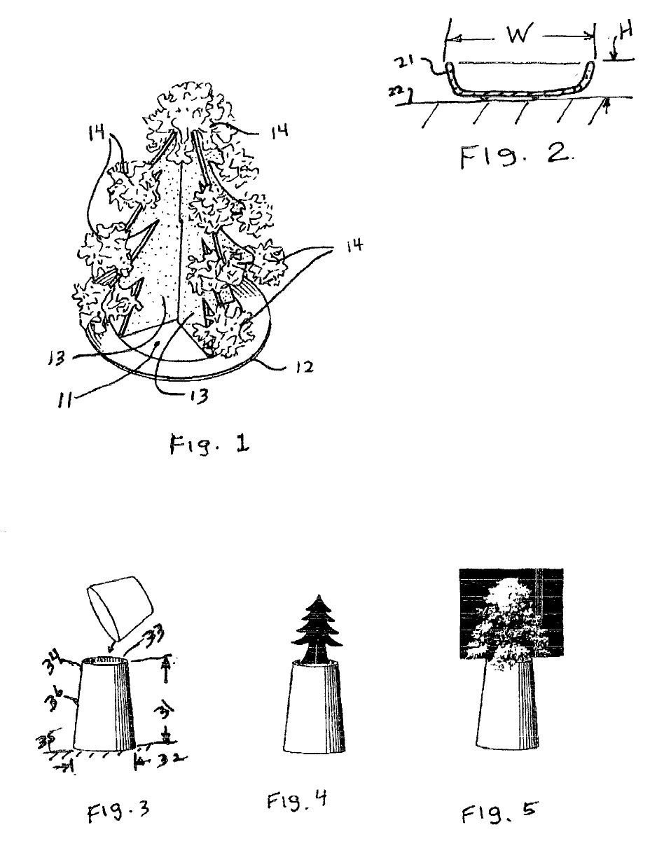

### DETAILED DESCRIPTION

### Embodiment of the Invention

The preferred embodiment of the invention has an aspect ratio of less than 1.0, and the height is ¾th inch or more, and the preferred height is 3 inches.

The preferred embodiment of the invention is an inverted drinking cup or object like unto it that when inverted provides a shape that retains a measure of liquid on the inverted base. Examples include paper and plastic cups with a bottom lip with raised circumference forming a depression. An example of the preferred shape is shown in FIG. 3 where the height is 31, the width is 32, and a depression 33 in the top 34 and the table top 35 on which the liquid holder 36 rests. The lip forms a depression that holds the liquid; the lip does not have to be pronounced, as only a small amount of liquid needs to be retained.

The absorbent material, when placed on the depression within the lip of the inverted cup, is thus in constant contact with the liquid, which is prevented form spilling or flowing away by the said lip. Furthermore, the low aspect ratio of the device as a whole facilitates the handling of the decorative crystalline growth and absorbent material and provides vertical gripping surfaces. Flat outer surfaces of the invention also provide a medium for printed communication such as directions for usage, advertisement, etc. This approach also takes advantage of the characteristic opposite end, providing a wide stable base resistant to toppling or falling over.

I claim:

1 an an inverted cup as an improved liquid holder for facilitating the. growing of decorative crystalline growths in air by:
a) providing a liquid holder wherein the liquid holder
b) uses a base, larger in area than the area of the upper surface, said base being more resistant to toppling, and
c) being commonly available, and
d) providing an outer surface amenable to printed communication, and
e) providing a low aspect ratio of width to height which provides a convenient gripping and manipulation method

2 an elevated liquid holder that has a width and a height, and where the aspect ratio of width divided by height is less than 1.5 and where the height i, 0.5 inches or more.

3 an elevated liquid holder that has a width and a height, and where the aspect ratio of width divided by height is less than 1.0 and where the height is 1.0 inches or more.
